(19) United States
(12) Patent Application Publication
(10) Pub. No.: US 2009/0032642 A1
(43) Pub. Date: Feb. 5, 2009

(54) MODULE FOR PLACEMENT IN A PASSENGER CABIN OF A MEANS OF TRANSPORT, MORE PARTICULARLY AN AIRPLANE

(76) Inventor: Johanna Sophia Margaretha ZWAAN, Den Dolder (NL)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 12/252,865

(22) Filed: Oct. 16, 2008

Related U.S. Application Data
(63) Continuation of application No. 10/544,804, filed on Jan. 8, 2007.

(51) Int. Cl. B64D 11/00

(52) U.S. Cl. 244/118.5

(57) ABSTRACT

A module (5) for placement in a passenger cabin (1) of a means of transport, such as an airplane, which passenger cabin (1) is provided with seats (2) in transverse and longitudinal rows, wherein the transverse rows are cut through, in longitudinal direction, by at least one aisle (3), which module (5) is provided with walls extending upwardly from a bottom of the passenger cabin (1) and with an access which is connected with an aisle (3). The module (5) is at least provided with two transverse walls (6, 7) which are connected in upward and/or sideward direction by deformable means with a ceiling (9) and/or sidewall (11) of the passenger cabin (1) and can be attached transversely to the longitudinal rows by means suitable for this purpose at a mutual distance substantially corresponding to the dimension which is taken up, in the direction of a longitudinal row, by the seats (2) to be given up for the placement of the module (5) in the passenger cabin (1), wherein further an access in the form of a closable door (7) is present.

### CROSS-REFERENCE TO RELATED APPLICATIONS

This application is a continuation of U.S. patent application Ser. No. 10/544,804 having a filing date of Jan. 8, 2007, which is a National Phase of International Application PCT/NL10/22580.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

### Field of the Invention

The invention relates to a module for placement in a passenger cabin of a means of transport, more particularly an airplane, which passenger cabin is provided with seats in transverse and longitudinal rows, wherein the transverse rows are cut through, in longitudinal direction, by at least one aisle, which module is provided with walls extending upwardly from a bottom of the passenger cabin and with an access in the form of a closable door connected with an aisle, wherein the module is at least provided with two transverse walls which are connected in upward direction with a ceiling of the passenger cabin and can be attached transversely to the longitudinal rows by means suitable for this purpose.

Such a module is known from U.S. Pat. No. 4,185,799. Here, a transverse wall is provided with an attachment system with locking means cooperating with the rails on which the passenger seats are fixed. The fixing construction is designed such that distortions in the airplane do not result in jamming of the door. Thus, a seamless connection which is good-looking in appearance can be realized on the bottom of the passenger cabin. Side and top connections of the transverse wall are evidently to be realized by adjusting the form of the transverse wall to the design of the passenger cabin.

Further, from U.S. Pat. No. 5,024,398, a module is known which has the form of a unit equipped as a one-man office space provided with a desk top, a seat, a telephone, a computer link or the like. The unit is provided with walls connected with the floor, which, at their top side, remain clear of the ceiling, while a wall or wall part has been left out to form an access, which may, for instance, be closed with a curtain. Because the space in an airplane is limited, the unit is designed such that, taking into account the elbow and leg room needed when sitting behind a desk, as little floor surface as possible is taken up. For this purpose, the unit has, for instance, a hexagonal design in cross section. A row of such units can be successively arranged centrally in the passenger cabin by leaving out, in longitudinal direction, seats normally present there. Because each unit needs to be individually accessible, no more than two cells can be placed next to each other. Particularly with wider airplanes, this leads to limitations with regard to optimal placement, that is, the most efficient possible surface utilization. Further, the units can only be used for the intended purpose, an office workplace; in other words, when no use is made of the office facilities, there will only be a seat taking up relatively much space.

Further, from EP-A-O 0355 955, a module is known in the form of a container, which can be slid into the cargo hold of an airplane and is equipped as a sleeping cabin. The purpose a that the container is arranged connectedly with the passenger cabin and is accessible from there. Such a container, which takes up extra-space because the persons using the sleeping facilities are, at least during landing and takeoff, in a seat in the passenger cabin, may, for instance, be used when less cargo needs to be transported than space allows. A similar unit is known from U.S. Pat. No. 4,458,864, where this unit is equipped as a mobile medical treatment room, which, for easy introduction into and removal out of a cargo hold of an airplane, can be provided with a ceiling movable in height direction. Such a unit needs to be able to be used both inside and outside the cargo hold of the airplane, which sets constructive requirements for both the ceiling and the bottom of the unit, and thus, in turn, has consequences for the weight of the whole unit. This weight is less important when the unit is placed in the cargo hold, yet it would be a clear drawback if placement in a passenger cabin were intended, where the weight of the unit should preferably not be is limited, the unit is designed such that, taking into account the elbow and leg room needed when sitting behind a desk, as little floor surface as possible is taken up. For this purpose, the unit has, for instance, a hexagonal design in cross section. A row of such units can be successively arranged centrally in the passenger cabin by leaving out, in longitudinal direction, seats normally present there. Because each unit needs to be individually accessible, no more than two cells can be placed next to each other. Particularly with wider airplanes, this leads to limitations with regard. to optimal placement, that is, the most efficient possible surface utilization. Further, the units can only be used for the intended purpose, an office workplace; in other words, when no use is made of the office facilities, there will only be a seat taking-up relatively much space.

Further, from EP-A-O 0355 955, a module is known in the form of a container, which can be slid into the cargo hold of an airplane and is equipped as a sleeping cabin. The purpose is that the container is arranged connectedly with the passenger cabin and is accessible from there. Such a container, which takes up extra-space because the persons using the sleeping facilities are; at least during landing and takeoff in a seat in the passenger cabin, may, for instance, be used when less cargo needs to be transported than space allows. A similar unit is known from U.S. Pat. No. 4,458,864, where this unit is equipped as a mobile medical treatment room, which, for easy introduction into and removal out of a cargo hold of an airplane, can be provided with a ceiling movable in height direction. Such a unit needs to be able to be used both inside and outside the cargo hold of the airplane, which sets constructive requirements for both the ceiling and the bottom of the unit, and thus, in turn, has consequences for the weight of the whole unit. This weight is less important when the unit is placed in the cargo hold, yet it would be a clear drawback if placement in a passenger cabin were intended, where the weight of the unit should preferably not be

Here, the desired closed room can be obtained when the transverse walls are connected, on both sides, with in each case one side wall of the passenger cabin and at least one of the transverse walls contains a door connected with an aisle. Thus, these transverse walls extend over the whole cross section of the passenger cabin and the door provides access to the closable module. The floor surface then available in the module then partly takes up the surface of the aisle or the aisles. Depending on the type of airplane, this may be less desired, for instance when the space behind the module needs to remain accessible, because toilets or a pantry are located there. It is true that a passage could be created with a second door, but this is considered less desirable when the module is intended as playing and/or sleeping accommodation, In such cases, according to a further embodiment of the invention, it may be preferred that the transverse walls are connected, on one side, with a sidewall of the passenger cabin and, on the other side, are connected with a longitudinal wall, which is adjacent to the aisle and extends from the bottom to the ceiling of the passenger cabin. In this embodiment, the aisle remains wholly available to the crew and the passengers in the passenger cabin. If, with wide airplanes with two aisles, they both need to remain passable without entering the module, this can be realized according to a further embodiment of the invention, when the transverse walls are connected, on both sides, with in each case one longitudinal wall, which is adjacent to the aisle and extends from the bottom to the ceiling of the passenger cabin. When a longitudinal wall extending parallel and adjacent to the aisle is used, a door providing access to the module can be present in this longitudinal wall. If two aisles are present and one aisle comes to an end at the module, it is preferred to provide a door there, because this door can then be provided so as to open inwards into the passenger cabin without becoming inconvenient. A door arranged parallel and adjacent to an aisle is preferably designed as a sliding door or swing panel door.

When the transverse walls extend over the whole cross section of the passenger cabin, the depth dimension of the module can simply be charged by placing the transverse walls further apart or, conversely, closer together. In order to obtain a same flexibility with a module with longitudinal wall(s), it can be preferred, in such an embodiment, that a longitudinal wail is assembled from at least two elements each having a width corresponding to a dimension which is taken up, in the direction of a longitudinal row, by one seat or a plurality of seats in a part of the passenger cabin where the module is to be placed.

A module designed for a particular type of airplane can also qualify for placement in a different type of airplane. In that different type of airplane, the dimension which is taken up, in the direction of a longitudinal row, by one seat or a plurality of seats may differ from that of the type of airplane referred to first. This could result in unused or lost space. In order to prevent this, according to a further embodiment of the invention, it is proposed that a longitudinal wall is assembled from at least two elements, at least one of which has a dimension which can be set and adjusted in width direction.

In order to be able to install a module according to the invention in a passenger cabin in a rapid and convenient manner, it is further preferred that a transverse wall is assembled from at least two elements.

In order to be able to equip the module for the intended purposes in a convenient and rapid manner, according to a further embodiment of the invention, it can be provided that at least one wall of the module is provided with supporting and bearing facilities for leisure facilities, such as a foldable sofa bed, a table top, a console, a washbasin, a climbing pole, a storage facility, a play structure, etc. Also, with a thus designed module, the requirement that, at least during takeoff and landing, no loose objects or elements are present can be met in a relatively simple manner.

In particular when the module is used as a playing cabin for children, it is preferred that a wall and/or the door is provided with a window, so that the parents traveling with them can observe their children without needing to enter the module. In such a use of the module, it is also preferred that the door is provided with a childproof latch and/or that the floor is provided with a non-slip covering.

Because an airplane may make sudden movements, it is further preferred that at least one of the transverse and/or longitudinal walls is, on the sides of the walls facing each other, at least partly provided with a resilient and/or sound-insulating wall or covering material.

It is known that playing children can produce quite a lot of noise, which can be rather disturbing to adult travelers. A module designed as a separate playing cabin offers a solution to this problem, especially when, according to a further embodiment of the invention, at least one of the transverse and/or longitudinal walls has a sandwich structure with a sound-insulating inner layer. Incidentally, this embodiment is also advantageous when the module is used as sleeping accommodation.

### BRIEF DESCRIPTION OF THE DRAWINGS

With reference to embodiments diagrammatically shown in the drawing, albeit exclusively by way of non-limiting examples, the module according to the invention will now be further elucidated, in which drawing:

FIG. 1 shows a plan of a first embodiment;

FIG. 2 shows an elevational view of the embodiment according to FIG. 1;

FIG. 3 shows a plan of a second embodiment; and

FIG. 4 shows an elevational view of the embodiment according to FIG. 3.

### DESCRIPTION OF THE PREFERRED EMBODIMENTS

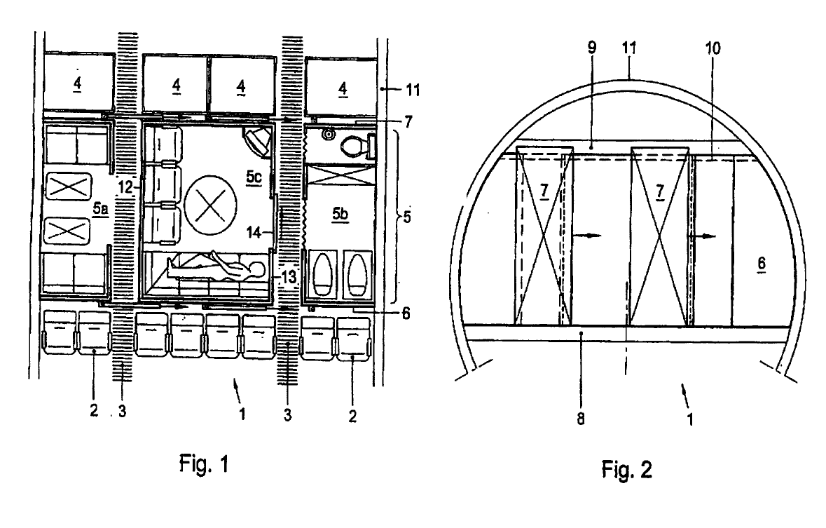

In FIG. 1, a part of a plan of a passenger cabin 1 of an airplane is shown, in which the seating is formed by seats 2 placed in transverse and longitudinal rows, while there are aisles 3 between the transverse rows, in the direction of the longitudinal rows. Further, there are a number of toilets 4 present. Connected with the toilets 4, a module 5 has been placed. For the purpose of being able to place the module 5, a number of transverse rows of seats 2 have been removed. The module 5 is formed by a transverse wall 6 and a transverse wall 7, which are each provided with two sliding doors 7 at the location where the aisles 8 extend through the module. The transverse walls 6 and 7 extend from a floor 8 of the passenger compartment 1 to a ceiling 9 thereof. At the connection with the ceiling 9, the transverse walls 6 and 7 are provided with a recess in which an inflatable hose 10 has been provided. The transverse walls are sealingly fixed to the floor 8 and further to the ceiling 9 and/or walls 11 of the airplane. The inflatable hose 10, which may further also extend between the transverse walls 6 and 7 and the airplane wall 11, ensures a fitting connection and sealing of the module with respect to the passenger cabin 1.

The module 5, which is primarily intended as playing and sleeping 15 room for children, is traversed by two aisles 8. Crew members and passengers walking over the aisles may be experienced as disturbing. For this reason, the module 5 is subdivided. Thus, a part 5a can be distinguished, in which seats and play areas for somewhat older children are arranged, that is, children who may be expected not to need constant supervision. Leaving out the sliding doors 7 at the location of part 5a could allow a direct view of these children. Further, a part 5b is present, which may be equipped for accommodation and care of babies, while, also, a children's toilet may be provided therein. The largest part of the module 5 is taken up by a part 5c, which is closed off from the aisles 3 by means of longitudinal walls 12 and 13, while an access in the form of a sliding door 14 has been provided in the longitudinal wall 13.

In the part 5c, play facilities for children may be accommodated, such as tables, sofas, climbing poles, a drinking fountain, cupboards for playthings, etc. The seating parts of the sofas may also be used as beds. By 30 making the back parts of the sofas foldable, these sofas may also be used as beds, while, thereabove, further facilities which are downwardly foldable for forming beds may be present, as diagrammatically designated in FIG. 4 by 16′, 16″ and 16′″. It is noted that these bed facilities may, if desired, also be intended for adult passengers, for instance when no or too few children are present on the flight to make efficient use of the module as a play facility.

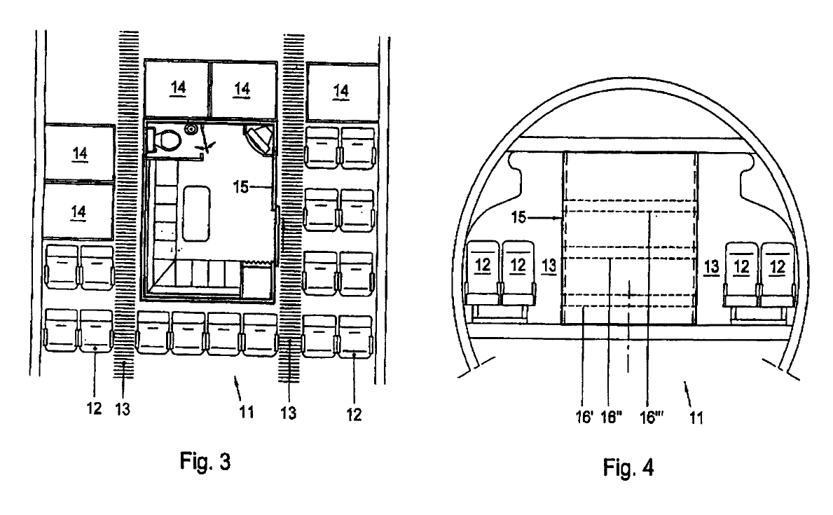

FIG. 3 shows a part of the plan of a passenger cabin 11, in which only in a part between the aisles 13, a module 15 has been placed, so that, next to the module 15, seats 12 or toilets 14 can be present.

It goes without saying that, within the scope of the invention as set forth in the appended claims, many more modifications and variants are possible. When the module is located at an end of the passenger cabin and ends there, for instance in a closed transverse partition, then the sliding doors in the respective transverse wall or even the whole transverse wall can be left out. Also, a module may extend over a central part, one aisle and a side part of the passenger cabin, while the longitudinal wall along the aisle not covered by the module does not need to have a door, but the transverse wall is provided with a door at the location where the other aisle comes to an end at this transverse wall. Further, for airplanes with a very wide middle part, the module could be smaller than this middle part, with seats having been placed directly connected with a longitudinal wall of the module.

1. A module for placement in a passenger cabin of a means of transport, more particularly an airplane, which passenger cabin is provided with seats in transverse and longitudinal rows, wherein the transverse rows are cut through, in longitudinal direction, by at least one aisle, which module is provided with walls extending upwardly from a bottom of the passenger cabin and with an access in the form of a closable door connected with an aisle, wherein the module is at least provided with two transverse walls which are connected in upward direction with a ceiling of the passenger cabin and can be attached transversely to the longitudinal rows by means suitable for this purpose, characterized in that, for connecting with the ceiling and/or the sidewalls, the walls can be arranged at a mutual distance substantially corresponding to the dimension which is taken up, in the direction of a longitudinal row, by the seats to be given up for the placement of the module in the passenger cabin.

2. A module according to claim 1, characterized in that the deformable means are accommodated in a recess provided in a top or side edge of the respective wall.

3. A module according to claim 1, characterized in that the deformable means are resilient.

4. A module according to claim 1, characterized in that the deformable means comprise an inflatable hose.

5. A module according to claim 1, characterized in that two transverse walls are, on one side, connected with a sidewall of the passenger cabin and are, on the other aide, connected with a longitudinal wall which is adjacent to an aisle and extends from the bottom to the ceiling of the passenger cabin.

6. A module according to claim 1, characterized in that the transverse walls are connected, on both sides, with in each case one longitudinal wall, in each case adjacent to an aisle and extending from the bottom to the ceiling of the passenger cabin.

7. A module according to claim 5, characterized in that a longitudinal wail is assembled front at least two elements each having a width corresponding to a dimension which is taken up, in the direction of a longitudinal row, by one seat or a plurality of seats in a part of the passenger cabin where the module is to be placed.

8. A module according to claim 5, characterized in that a longitudinal wall is assembled from at least two elements, at least one of which has a dimension which can be set and adjusted at least in width direction.

9. A module according to claim 1, characterized in that at least one wall of the module is provided with supporting and bearing facilities for leisure facilities, such as a foldable sofa bed, a table top, a console, a washbasin, a climbing pole, a storage facility, a play structure, etc.

10. A module according to claim 1, characterized in that at least one wall and/or door is provided with a window.

11. A module according to claim 1, characterized in that each door is provided with a childproof latch.

12. A module according to claim 1, characterized in that the floor is provided with a non-slip covering.

13. A module according to claim 1, characterized in that at least one of the transverse and/or longitudinal walls is, on the sides of the walls facing each other, at least partly provided with a resilient and/or sound-insulating wall or covering material.

14. A module according to claim 1, characterized in that at least one of the transverse and/or longitudinal walls has a sandwich structure with a sound-insulating inner layer.
